(19) United States
(12) Patent Application Publication
(10) Pub. No.: US 2014/0096104 A1
(43) Pub. Date: Apr. 3, 2014

(54) Comparing Target Effort to Actual Effort for Software Development Requirements

(71) Applicant: HEWLETT-PACKARD DEVELOPMENT COMPAN, (US)

(72) Inventors: Miroslav Novak, Prague (CZ); Jan Maska, Prague (CZ); Albert Regner, Prague (CZ)

(73) Assignee: HEWLETT-PACKARD DEVELOPMENT COMPANY, L.P., Houston, TX (US)

(21) Appl. No.: 13/629,689

(22) Filed: Sep. 28, 2012

(51) Int. Cl. G06F 9/44

(52) U.S. Cl. CPC G06F 8/70
USPC 717/101

(57) ABSTRACT

A target amount of effort to spend on requirements of a software development project may be determined. A visualization can be displayed comparing the target amount of effort to an actual amount of effort spent on the requirements. In an example, the effort may be represented as time.

### BACKGROUND

Development of software can be challenging. Many software projects are large and have multiple requirements setting forth features, functionality, and the like, that are supposed to be implemented by the software. The various requirements often have different business justifications and can have varied importance. Additionally, the development team can include many people, including software developers, software designers, software architects, and development managers. It is often the case that many members of the development team played no part in creating the requirements of the software project. Rather, their job is to implement the requirements.

### BRIEF DESCRIPTION OF DRAWINGS

The following detailed description refers to the drawings, wherein:

FIG. 1 illustrates a computing system for generating a visualization comparing target effort to actual effort, according to an example.

FIG. 2 illustrates a computing system for generating a visualization that compares target effort to actual effort and indicates risk, according to an example.

FIG. 3 illustrates a visualization, according to an example.

FIG. 4 illustrates a method of generating a visualization, according to an example.

FIG. 5 illustrates a method of generating a visualization based on user input, according to an example.

FIG. 6 illustrates a computer-readable medium for generating a visualization, according to an example.

### DETAILED DESCRIPTION

For a software development project having multiple requirements, it can be useful to align engineering effort with business value. Because of the difficulty associated with developing software and managing a large project, sometimes development teams spend an inordinate amount of time on features of the software that have little business value while not spending enough time on features having higher business value.

According to an embodiment, a visualization may be generated to identify a misalignment between development effort and business value. The various requirements of a software project can have different business justifications and different business value. This can affect the overall importance of each requirement. Accordingly, a target amount of effort (e.g., time) to spend on each requirement can be determined. The target amount of effort can be determined based on a priority associated with each requirement and based on an available capacity of effort.

Additionally, an actual amount of effort spent on each requirement may be determined. The actual effort may be determined based on information maintained by a source code management program, which can track development effort. A visualization can be generated comparing the amount of effort spent on one or more of the requirements to the target amount of effort to spend on the one or more requirements. The visualization can be displayed and thus misalignment between development effort and business value can be easily detected.

Furthermore, a risk associated with each requirement, such as a risk that the requirement may not be successfully implemented, may be displayed on the visualization. Additionally, a user may have the option of modifying an overall importance of priority and risk in the visualization by modifying a weight assigned to each. By modifying the weights, the calculated values represented in the visualization can change accordingly.

Further details of this embodiment and associated advantages, as well as of other embodiments, will be discussed in more detail below with reference to the drawings.

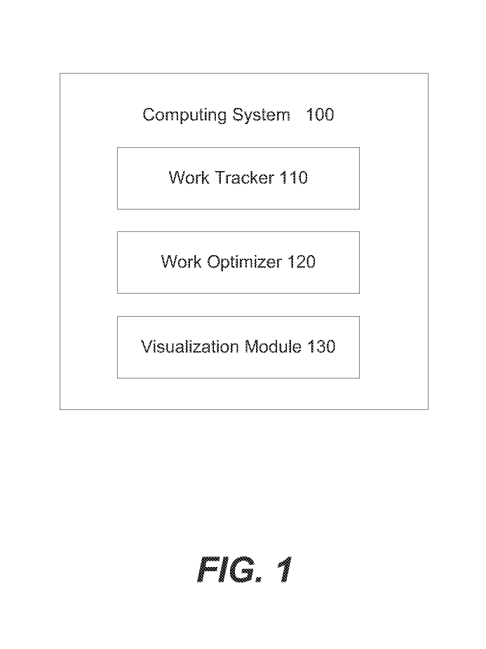

Referring now to the drawings, FIG. 1 illustrates a computing system for generating a visualization comparing target effort to actual effort, according to an example. Computing system 100 may include and/or be implemented by one or more computers. For example, the computers may be server computers, workstation computers, desktop computers, or the like. The computers may include one or more controllers and one or more machine-readable storage media.

A controller may include a processor and a memory for implementing machine readable instructions. The processor may include at least one central processing unit (CPU), at least one semiconductor-based microprocessor, at least one digital signal processor (DSP) such as a digital image processing unit, other hardware devices or processing elements suitable to retrieve and execute instructions stored in memory, or combinations thereof. The processor can include single or multiple cores on a chip, multiple cores across multiple chips, multiple cores across multiple devices, or combinations thereof. The processor may fetch, decode, and execute instructions from memory to perform various functions. As an alternative or in addition to retrieving and executing instructions, the processor may include at least one integrated circuit (IC), other control logic, other electronic circuits, or combinations thereof that include a number of electronic components for performing various tasks or functions.

The controller may include memory, such as a machine-readable storage medium. The machine-readable storage medium may be any electronic, magnetic, optical, or other physical storage device that contains or stores executable instructions. Thus, the machine-readable storage medium may comprise, for example, various Random Access Memory (RAM), Read Only Memory (ROM), flash memory, and combinations thereof. For example, the machine-readable medium may include a Non-Volatile Random Access Memory (NVRAM), an Electrically Erasable Programmable Read-Only Memory (EEPROM), a storage drive, a NAND flash memory, and the like. Further, the machine-readable storage medium can be computer-readable and non-transitory. Additionally, computing system 100 may include one or more machine-readable storage media separate from the one or more controllers.

Computing system 100 may include work tracker 110, work optimizer 120, and visualization module 130. Each of these components may be implemented by a single computer or multiple computers. The work tracker 110, work optimizer 120, and visualization module 130 include software modules, one or more machine-readable media for storing the software modules, and one or more processors for executing the software modules. A software module may be a computer program comprising machine-executable instructions.

In addition, users of computing system 100 may interact with computing system 100 through one or more other computers, which may or may not be considered part of computing system 100. As an example, a software developer may interact with code tracker 110 or visualization module 130 via a computer application residing on another computer, such as a desktop computer, workstation computer, tablet computer, or the like.

The functionality implemented by work tracker 110, work optimizer 120, and visualization module 130 may be features of a software development platform executed by computing system 100. The software development platform may be a single or multiple software applications that facilitate the development and management of software. For example, the platform may include a source code management program to manage the code base, track changes, and track the authors of the changes. The source code management program may maintain a copy of the code base and may accept changes to the code base from developers. The source code management program may thus maintain a history of the code base and may also manage conflicts, ensuring that the same portion of the code base is not simultaneously modified by different developers. The platform may also include a project management program, which can track requirements, facilitate testing, track defects, and provide analysis capabilities. The project management program can interface with the source code management program to link requirements and defects with portions of the code base, past changes, etc.

The platform may also include an integrated development environment (IDE), which can provide a software development interface for software developers. The IDE can provide a user-friendly interface to developers for coding, checking code into the source code management program, indicating relevant information regarding requirements or defects that the code relates to, and the like. In some embodiments, the functionality of the work tracker 110, work optimizer 120, and visualization module 130 may be implemented by combinations of these components. Furthermore, in some examples, the software development platform can take a different form, where the functionality is implemented by a single application or component or by different applications or components than described here.

Work tracker 110 may track changes to a code base. The work tracker 110 may maintain a copy of the code base. The code base may be the collection of source code used to build a particular software program being developed. Work tracker 110 may also manage changes for modifications) to the code base. For example, work tracker 110 may accept a set of changes (sometimes referred to as a “change set”) from a first developer and another change set from a second developer to different portions of the code base and may maintain a history of the changes, such that prior versions of the code base may be reconstructed and such that changes to the code base can be traced. A change set may also include a new addition to the code base, such as a new class or software module. The work tracker 110 may also ensure that two developers do not modify the same portion of code at the same time.

Work tracker 110 may also record information regarding each change set. For example, work tracker 110 may record the author of the change set and the date that the change set was checked in to the work tracker. Work tracker 110 may record other information related to the purpose of the change set. For example, work tracker 110 may record which requirement the change set is meant to implement or which defect the change set is meant to address. In an example, the requirement or the defect may be entered by the developer. Work tracker 110 may also record an estimated amount of time spent on the change set. For example, the developer checking in the change set may enter how much time he spent working on the changes in the change set.

Based on the information recorded by work tracker 110, an actual amount of effort spent on a requirement can be determined. In one example, the amount of effort may be represented by a number of committed change sets that implement the requirement. A more specific representation of the amount of effort can be a number of changed lines of code within those change sets. In another example, the amount of effort may be represented by the estimated amount of developer time spent implementing the change sets. Additionally, where a change set is related to a defect instead of a requirement, the defect can be linked to a particular requirement. For example, a developer or project manager may review the defects and link them to the most appropriate requirement. This may provide a more full or comprehensive view of how much development time is being spent on the various requirements. In some examples, work tracker 110 may be configured to determine an amount of effort spent one each requirement without being responsible for tracking the development activity. In this case, work tracker 110 may interface with a source code management program to retrieve the appropriate information.

Work optimizer 120 may calculate a target amount of effort to spend on each requirement. In one example, work optimizer 120 can be configured to calculate the target amount of effort based on an available capacity of effort for a target time period and a priority associated with each requirement. The available capacity of effort may be based on a number of available developer hours if effort is represented by time. Alternatively, the available capacity of effort may be based on a number of change sets or changed lines of code that are, on average, able to be implemented during an amount of time represented by the target time period (e.g., one week, one month, one year, etc.). The priority of each requirement may be determined and set beforehand by member of the development team and/or a businessman. Additional details, including example formulas, for calculating the target amount of effort are described in more detail below.

The visualization module 130 generate a visualization showing the amount of effort spent on one or more requirements relative to the calculated target amount of effort to spend on the one or more requirements. The visualization may be displayed via a user interface. In some examples, the displayed effort representations for each requirement may be ordered based on priority. For instance, the highest priority requirements may have their representations displayed to the left while representations of lower priority requirements are displayed to the right.

In an example, the work optimizer 120 may be configured to calculate the optimum amount of effort to spend on each requirement based on a priority weight. the priority weight may indicate an amount of weight to give the priority associated with each requirement. For example, the higher the priority weight, the more emphasis is given to the priority for each requirement. Accordingly, a requirement with a higher priority may be given correspondingly more importance (in the form of increased target effort) than a requirement having a lower priority.

As a simplified example, assume a first requirement has priority 1 and a second requirement has priority 2. If the priority weight is 0, an initial distribution of target effort may allocate the same amount of effort to the requirements. However, if the priority weight is increased from 0 to 50 (on a 100 point scale), the target effort may be recalculated such that the first requirement is allocated twice the amount effort as the second requirement. Further, if the priority weight is increased from 50 to 100, the target effort may be recalculated such that the first requirement is allocated four times as much effort as the second requirement. Accordingly, the priority weight may impact the target amount of effort in a non-linear manner.

In an example, the actual amount of effort spent on a requirement may be calculated as a normalized value as follows:

$${RNEffort}_{i} = {RNEffort}_{i} * ( \frac{2 * PriorityWeight}{100} ) * \frac{TotalWorkDone}{\sum {REffort}_{i} * \frac{2 * PriorityWeight}{100}}$$

where RNEffortᵢ is the normalized actual effort spent on requirement i, REffortᵢ is the actual effort spent on requirement i, PriorityWeight is the specified priority weight, and TotalWorkDone is the total effort for the relevant time period.

In an example, the target amount of effort for each requirement may be calculated as follows:

$${RTarget}_{i} = {RPriority}_{i} * \frac{2 * PriorityWeight}{100} * \frac{TotalAvailableCapacity}{\sum {RPriority}_{i} * \frac{2 * PriorityWeight}{100}}$$

where RTargetᵢ is the target effort for requirement i, RPriorityᵢ is the priority of requirement i, and TotalAvailableCapacity is the total available capacity of effort available for the relevant time period.

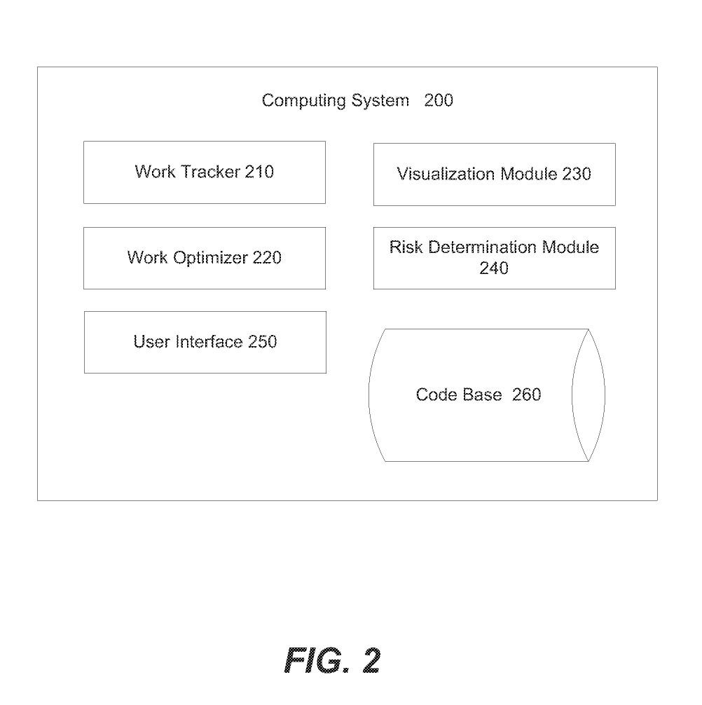

FIG. 2 illustrates a computing system for generating a visualization that compares target effort to actual effort and indicates risk, according to an example. Computing system 200 may be similar to computing system 100, as described above. The work tracker 210, work optimizer 220, and visualization module 230 may also be similar to the identically named elements in computing system 100. Computing system 200 may also include a risk determination module 240, a user interface 250, and a code base 260. Code base 260 may be a database for storing the code base. Code base 260 may include one or more data storage devices and may be spread across one or more computers, such as server computers. Code base 260 may be managed by the source code management program.

User interface 250 may include hardware components and software components. The hardware components may include input devices (e.g., keyboard, mouse, touch screen, microphone, etc.) and output devices (e.g., a display, a touch display, speakers, etc.). The hardware components may be part of a user's device used to interact with computing system 200. The software components may include one or more graphical user interfaces implemented by the user's device that interface with the user for receiving input and providing output. In some examples, user interface 250 can be considered to include only the software component.

The user interface 250 may interface with other components of computing system 200. Accordingly, for example, user interface 250 may be used to interact with the software development platform and may be a part of the platform. For example, user interface 250 may be an interface for the source code management program, the project management application, or the IDE.

User interface 250 may be used to specify values to be used by the visualization module 230 or work optimizer 220. For example, user interface 250 may be used to specify the priority weight. User interface 250 may also be used to commit change sets to the code base. In particular, user interface 250 may be used to specify one or more requirements implemented by a change set or one or more defects addressed by a change set. User interface 250 may additionally be used to display a generated visualization.

Risk determination module 240 may determine a relative risk of each requirement relative to the other requirements and may generate an indication of the relative risk. Each requirement may be associated with a risk. For example, the risk may be a risk of failure that is, a risk that the requirement may not be successfully implemented. The risk of each requirement may be specified by someone on the development team, such as a project manager. The risks may be stored in memory in association with the requirements. In addition, the risk determination module 240 may be configured to further determine the relative risk of each requirement based on a risk weight. The risk weight may indicate an amount of weight to give the risk associated with each requirement. The risk weight may work similarly to the priority weight described previously. For example, the risk weight may impact the relative risk of the requirements in a non-linear manner. Visualization module 230 may be configured to display an indication of the relative risk of one or more requirements.

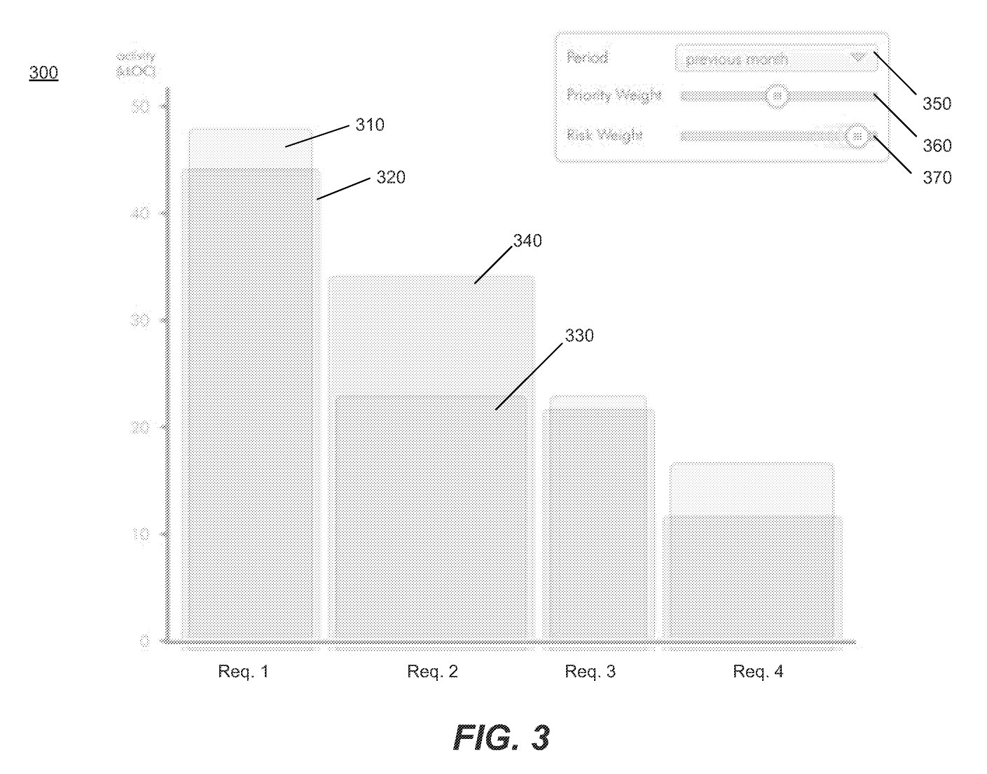

FIG. 3 illustrates a visualization, according to an example. The visualization includes a bar graph showing information for a plurality of requirements, requirements 1-4. Each set of bars represents a requirement. For example, bars 310 and 320 represent information regarding requirement 1 and bars 330 and 340 represent information regarding requirement 2. The inner bars (e.g., bars 310 and 330) represent actual effort for the respective requirements, while the outer bars (e.g., bars 320 and 340) represent target effort for the respective requirements.

The height of the bars represents an amount of effort. In this example, effort is measured by lines of code. Accordingly, for actual effort, the inner bars represent the number of lines of code that were modified during the relevant time period. For target effort, the outer bars represent a target number of lines of code that were expected to be modified. The higher priority requirements are located to the left of the graph while the lower priority requirements are position to the right of the higher priority requirements. The width of the bars represents a risk of the requirement relative to the other requirements.

Selectors 350, 360, 370 are graphical user interface elements for specifying values to be used in the visualization. Selector 350 allows a user to select a period of time for the visualization. For example, as shown, selector 350 is set to “previous month”, meaning that actual effort and target effort are being considered for the previous month. Selector 360 allows a user to specify the priority weight. Selector 370 allows a user to specify the risk weight. These values can be used in the visualization as described previously.

As is apparent, the visualization can easily demonstrate whether there is a misalignment between actual effort and target effort. As described previously, this can indicate whether development activity matches business objectives and value. For example, it can be seen that actual effort 310 for requirement 1 is greater than target effort 320. This can indicate any of various issues. For example, it may indicate that there has been too much focus on requirement 1. This could easily happen due to the high priority of requirement 1. Alternatively, it can indicate that requirement 1 is hard to implement. However, the visualized risk, as indicated by the width of bars 310 and 320, indicates that requirement 1 was not initially considered hard to implement. This type of information can be useful for future planning for this software project and for future software projects.

Turning to requirement 2, it can be seen that actual effort 330 is much lower than target effort 340. This too can indicate that there is a problem. For example, it could indicate that there has not been enough focus on requirement 2. Alternatively, it could indicate that requirement 2 was easy to implement. However, the high depicted risk, as indicated by the width of bars 330, 340 contradicts this theory. Again, this information can be used for future planning purposes, for recalibrating the current project, for training developers, and the like.

Sometimes a difference between actual effort and target effort may be within an allowable range that accounts for the difficulty of predicting development effort. The actual effort and target effort bars for requirement 3 are an example where the difference is small enough that it may be assumed that development effort is in line with business priorities.

In an example, the height of the bar representing target effort for a given requirement may be computed as follows:

$${RTargetHeight}_{i} = {RTarget}_{i} * \frac{TotalHeight * \frac{1 + VerticalReserve}{100}}{max ( {RTarget}_{i} , R N {Effort}_{i} )}$$

where RTargetHeightᵢ is the height of the area representing target effort for requirement i, TotalHeight is the vertical space available for the visualization, and VerticalReserve is the space reserved in the top part of the visualization.

In an example, the height of the bar representing actual effort for a given requirement may be computed as follows:

$$R N {EffortHeight}_{i} = R N {Effort}_{i} * \frac{TotalHeight * \frac{1 + VerticalReserve}{100}}{max ( {RTarget}_{i} , R N {Effort}_{i} )}$$

where RNEffortHeightᵢ is the height of the area representing actual effort for requirement i, TotalHeight is the vertical space available for the visualization, and VerticalReserve is the space reserved in the top part of the visualization.

In an example, the width of the bars for a given requirement may be computed as follows:

$${Width}_{i} = {RRisk}_{i} * \frac{2 * RiskWeight}{100} * \frac{TotalWidth}{\sum {RRisk}_{i} * \frac{2 * RiskWeight}{100}}$$

where Widthᵢ is the width of the area for requirement i, RRiskᵢ is the risk associated with requirement i, RiskWeight is the specified risk weight, and TotalWidth is the horizontal space available for the visualization. The width of the target effort bar may be made larger than the width of the actual effort bar so that the two bars can be distinguishable in the visualization. As an example, the width of the target effort bar may be 10% greater than the width of the actual effort bar.

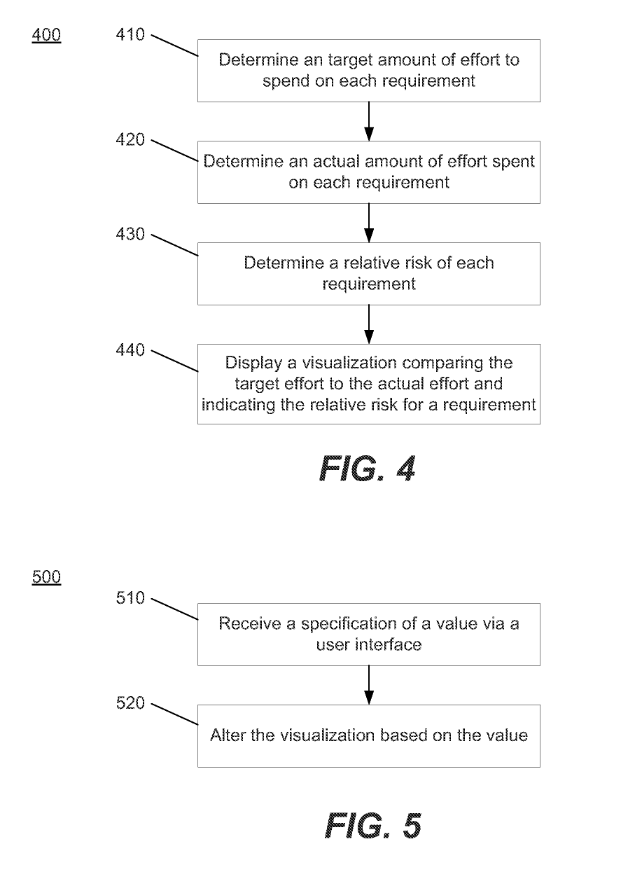

FIG. 4 illustrates a method of generating a visualization, according to an example. Method 400 may be implemented by a computing system, such as system 100 or 200. At 410, a target amount of effort to spend on each requirement is determined. At 420, an actual amount of effort spent on each requirement is determined. At 430, a relative risk of each requirement is determined. At 440, a visualization is generated and displayed on a display. The visualization may compare the target amount of effort to the actual amount of effort for at least some of the requirements. The visualization may also indicate the relative risk of the at least some requirements.

FIG. 5 illustrates a method of generating a visualization based on user input, according to an example. Method 500 may be implemented by a computing system, such as system 100 or 200. At 510, a specification of a value may be received from a user via a user interface. At 520, the value may be used to alter the visualization. For example, a user may specify a priority weight. The priority weight may impact the target amount of effort for each requirement in a non-linear manner. In addition, a user may specify a risk weight. The risk weight may impact the relative risk of each requirement in a non-linear manner. In another example, a user may specify a time period. The visualization may be limited to information (e.g., development activity) from the specified time period.

In another example, multiple visualizations may be displayed to show a trend. For example, a series of visualizations from different time periods may be combined to show a trend in development activity over the time periods. For instance, a three-dimensional visualization may be generated, where the third dimension can indicate different time periods. Accordingly, multiple visualizations corresponding to different time periods, such as consecutive months, may be stacked against each other and displayed in a three dimensional fashion to enable the identification and analysis of trends.

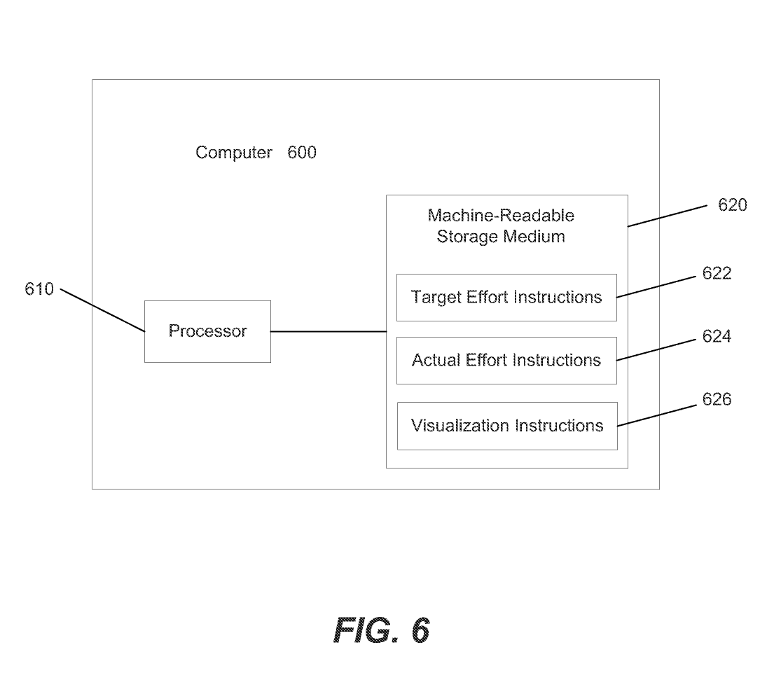

FIG. 6 illustrates a computer-readable medium for generating a visualization, according to an example. Computer 600 may be any of a variety of computing devices or systems, such as described with respect to computing system 100 or 200.

Processor 610 may be at least one central processing unit (CPU), at least one semiconductor-based microprocessor, other hardware devices or processing elements suitable to retrieve and execute instructions stored in machine-readable storage medium 620, or combinations thereof. Processor 610 can include single or multiple cores on a chip, multiple cores across multiple chips, multiple cores across multiple devices, or combinations thereof. Processor 610 may fetch, decode, and execute instructions 622, 624, 626, among others, to implement various processing. As an alternative or in addition to retrieving and executing instructions, processor 610 may include at least one integrated circuit (IC), other control logic, other electronic circuits, or combinations thereof that include a number of electronic components for performing the functionality of instructions 622, 624, 626. Accordingly, processor 610 may be implemented across multiple processing units and instructions 622, 624, 626 may be implemented by different processing units in different areas of computer 600.

Machine-readable storage medium 620 may be any electronic, magnetic, optical, or other physical storage device that contains or stores executable instructions. Thus, the machine-readable storage medium may comprise, for example, various Random Access Memory (RAM), Read Only Memory (ROM), flash memory, and combinations thereof. For example, the machine-readable medium may include a Non-Volatile Random Access Memory (NVRAM), an Electrically Erasable Programmable Read-Only Memory (EEPROM), a storage drive, a NAND flash memory, and the like. Further, the machine-readable storage medium 620 can be computer-readable and non-transitory. Machine-readable storage medium 620 may be encoded with a series of executable instructions for managing processing elements.

The instructions 622, 624, 626, when executed by processor 610 (e.g., via one processing element or multiple processing elements of the processor) can cause processor 610 to perform processes, for example, the processes depicted in FIGS. 4 and 5. Furthermore, computer 600 may be similar to computing systems 100 or 200 and may have similar functionality and be used in similar ways, as described above.

Target effort instructions 622 can cause processor 610 to determine a target amount of effort to spend on each requirement of a plurality of requirements. The plurality of requirements may be related to a software project. The target amount of effort may be determined based on a priority associated with each requirement. Actual effort instructions 624 can cause processor 610 to receive an actual amount of time spent on each requirement. The actual amount of time may be received from a source code management program. Visualization instructions 626 can cause processor 610 to display a visualization that compares the target amount of time to the actual amount of time for each requirement.

What is claimed is:

1. A computing system for software development, comprising:
a work tracker to track an amount of effort spent on each requirement of a plurality of requirements;
a work optimizer to calculate a target amount of effort to spend on each requirement of the plurality of requirements; and
a visualization module to display on a display the amount of effort spent on a first requirement of the requirements relative to the calculated target amount of effort to spend on the first requirement.

2. The computing system of claim 1, wherein the work optimizer is configured to calculate the target amount of effort to spend on each requirement based on an available capacity of effort and a priority associated with each requirement.

3. The computing system of claim 2, wherein the visualization module is configured to display on a single screen the amount of effort spent on multiple ones of the plurality of requirements relative to the calculated target amount of effort to spend on the multiple ones of the plurality of requirements, wherein the requirements are ordered according to the priority associated with the requirements.

4. The computing system of claim 2, wherein the work optimizer is further configured to calculate the target amount of effort to spend on each requirement based on a priority weight, the priority weight indicating an amount of weight to give the priority associated with each requirement.

5. The computing system of claim 4, further comprising a user interface to specify the priority weight.

6. The computing system of claim 1, further comprising:
a risk determination module to determine a relative risk of each requirement relative to the other requirements,
wherein the visualization module is configured to display an indication of the relative risk of the first requirement, the relative risk of the first requirement representing a likelihood that the first requirement may not be successfully implemented.

7. The computing system of claim 6, wherein the indication of the relative risk of the first requirement is a width of a bar representing the calculated target amount of effort to spend on the first requirement.

8. The computing system of claim 6, wherein the risk determination module is configured to determine the relative risk of each requirement based on a risk associated with each requirement.

9. The computing system of claim 8, wherein the risk determination module is further configured to determine the relative risk of each requirement based on a risk weight, the risk weight indicating an amount of weight to give the risk associated with each requirement.

10. A method comprising:
determining a target amount of effort to spend on each requirement of multiple requirements in a software development project;
determining an actual amount of effort spent on each requirement;
determining a relative risk of each requirement; and
displaying on a display a visualization that compares the target amount of effort to the actual amount of effort for at least some of the requirements and that indicates the relative risk of the at least some of the requirements.

11. The method of claim 10, further comprising receiving a specification of a priority weight via a user interface, wherein the priority weight impacts the target amount of effort for the multiple requirements in a non-linear manner.

12. The method of claim 10, further comprising receiving a specification of a risk weight via a user interface, wherein the risk weight impacts the relative risk of the multiple requirements in a non-linear manner.

13. The method of claim 10, further comprising receiving a specification of a time period via a user interface, wherein the visualization is limited to the time period.

14. The method of claim 13, further comprising displaying multiple visualizations to show a trend over a series of time periods.

15. A non-transitory computer-readable storage medium comprising instructions that, when executed by a processor, cause the processor to:
determine a target amount of time to spend on each requirement of a plurality of requirements for a software project based on a priority associated with each requirement;
receive an actual amount of time spent on each requirement from a source code management program; and
display a visualization comparing the target amount of time to the actual amount of time for each requirement.
